(19) United States
(12) Patent Application Publication
(10) Pub. No.: US 2024/0414600 A1
(43) Pub. Date: Dec. 12, 2024

(54) SIGNALING FOR INTER-RAT HANDOVER OF REDCAP UES

(71) Applicant: Telefonaktiebolaget LM Ericsson (publ), Stockholm (SE)

(72) Inventors: Yazid Lyazidi, London (GB); Qian Chen, Mölndal (SE); Emre Yavuz, Stockholm (SE); Paul Schliwa-Bertling, Ljungsbro (SE); Tuomas Tirronen, Helsinki (FI)

(21) Appl. No.: 18/696,445

(22) PCT Filed: Sep. 30, 2022
(86) PCT No.: PCT/SE2022/050869

§ 371 Date: Mar. 28, 2024

Related U.S. Application Data
(60) Provisional application No. 63/251,112, filed on Oct. 1, 2021.

(51) Int. Cl. H04W 36/00

(52) U.S. Cl. CPC H04W 36/0022; H04W 36/00838

(57) ABSTRACT

Systems and methods are disclosed for signaling Reduced Capability (RedCap) wireless communication device (WCD) capability during inter-Radio Access Technology (RAT) handover. In one embodiment, a method performed by a target network node for inter-RAT handover of a WCD from a source network node of a first RAT to the target network node of a second RAT comprises receiving, at the target network node, a message in association with preparation or execution of a handover of a WCD from the source network node of the first RAT to the target network node of the second RAT, the message comprising information about one or more capabilities of the WCD. The method further comprises determining that the WCD is a RedCap WCD based on the information about the one or more capabilities of the WCD and sending an indication that the WCD is a RedCap WCD to a core network node.

### RELATED APPLICATIONS

This application claims the benefit of provisional patent application Ser. No. 63/251,112, filed Oct. 1, 2021, the disclosure of which is hereby incorporated herein by reference in its entirety.

### TECHNICAL FIELD

The present disclosure relates to a cellular communications system and, more specifically, inter-Radio Access Technology (RAT) handover.

### BACKGROUND

Reduced Capability (RedCap) Release-17 Work Item Description (WID) Recently in the 3rd Generation Partnership Project (3GPP), Reduced Capability (RedCap) capabilities have been included in User Equipments (UEs). Such UEs are referred to as “RedCap UEs”. For example, the New Radio (NR) RedCap (NR RedCap) Work item Description (WID) is detailed in RP-211574. See Revised WID on support of reduced capability NR devices, 3GPP TSG RAN Meeting #92e, RP-211574, Jun. 14-18, 2021. RP-211574 describes the generic requirements for RedCap UE as:
Device complexity: Main motivation for the new device type is to lower the device cost and complexity as compared to high-end enhanced Mobile Broadband (eMBB) and Ultra-Reliable Low-Latency (URLLC) devices of 3GPP Rel-15/Rel-16.
Device size: Requirement for most use cases is that the standard enables a device design with compact form factor.
Deployment scenarios: System should support all Frequency Range 1 (FR1)/Frequency Range 2 (FR2) bands for Frequency Division Duplexing (FDD) and Time Division Duplexing (TDD).
Additionally, RP-211574 briefly describes use-case specific requirements:
Industrial wireless sensors: Reference use cases and requirements are described in 3GPP Technical Report (TR) 22.832 and 3GPP Technical Specification (TS) 22.104. See 3GPP TR 22.832, v17.4.0, Technical Specification Group Services and System Aspects, Study on enhancements for cyber-physical control applications in vertical domains, Stage 1 (Release 17), 03-2021; See also 3GPP TS 22.104 v18.2.0, Technical Specification Group Services and System Aspects, Service requirements for cyber-physical control applications in vertical domains, Stage 1 (Release 18), 09-2021.
Wearable surveillance, as described in 3GPP TR 22.084. See 3GPP TR 22.804, v16.3.0, Technical Specification Group Services and System Aspects, Study on Communication for Automation in Vertical Domains (Release 16), 07-2020.
Wearables: Reference bitrate for smart wearable application can be 5-50 Megabits per second (Mbps) in downlink (DL) and 2-5 Mbps in uplink (UL), and peak bit rate of the device can be higher, up to 150 Mbps for downlink and up to 50 Mbps for uplink. Battery of the device should last multiple days (up to 1-2 weeks).

Techniques for UE complexity reduction, coverage recovery, and UE power saving for these use cases have been studied in the RedCap study item documented in 3GPP TR 38.875. See 3GPP TR 38.875, v17.0.0, Technical Specification Group Services and System Aspects, Study on support of reduced capability NR devices (Release 17), 03-2021.

Additionally, during the System Information (SI) phase, mechanisms to ensure that RedCap UEs are only used for the intended use cases were discussed. The following mechanisms were listed in the TR for constraining the service or use or resources (See Id., clause 10.2.1):
Option 1: Radio Resource Control (RRC) Reject based approach
Option 2: Subscription validation
   E.g., including an indication in Non-Access Stratum (NAS) signaling to the core network (CN) or Radio Access Network (RAN) informs the CN after it knows the UE is a RedCap UE.
Option 3: Verification of RedCap UE
   Network performs a capability match between UE's reported capabilities and RedCap UE type.
Option 4: Left up to network implementation to ensure RedCap UE uses intended services and/or resources.

In the 3GPP SA2 #146-E meeting on Aug. 16-27, 2021, the 3GPP Technical Specification Group Service and System Aspects (TSG SA) WG2 (SA2) has discussed the above options and agreed on a new functionality in the CN documented in S2-2106979, which requires signaling between RAN and CN for RedCap UE identification. See Support RedCap UEs differentiation in 5GC, 3GPP TSG-WG SA2 Meeting #146E e-meeting S2-2106979, Aug. 16-27, 2021 (Hereinafter “S2-2106979”). This new indication about the UE being a RedCap UE will be signaled over NG/N2 interface to support subscription validation and any other necessary functionality based on differentiation between RedCap and non-RedCap UEs. Such features can include different charging for RedCap, knowing the UE is a RedCap UE for configuring possible operator-specific access categories for RedCap or different policy control, roaming, etc. A similar mechanism also exists for legacy Evolved Universal Radio Access (E-UTRA) LTE for Machine Type Communication (LTE-M) identification in CN over NG interface.

### Inter-Rat Handover

In 3GPP TS 38.300, Inter-Radio Access Technology (RAT) mobility is characterized. See 3GPP TS 38.300 v16.7.0, Technical Specification Group Radio Access Network, NR, NR and NG-RAN overall description, Stage 2 (Release 16), 09-2021 (hereinafter “TS 38.300”). Specifically, inter-RAT mobility is characterized in 3GPP TS 38.300 by the following:
The Source RAT configures Target RAT measurement and reporting.
The source RAT decides on the preparation initiation and provides the necessary information to the target RAT in the format required by the target RAT:
For handover preparation from E-UTRA to NR, the source RAT issues a handover preparation request message to the target RAT passing a transparent RRC container with necessary information to prepare the handover at the target side. The information for the target RAT is the same type as specified in clause 9.2.3.2.1 of 3GPP TS 38.300 including the current Quality of Service (QOS) flow to data radio bearer (DRB) mapping applied to the UE and Radio Resource Management (RRM) configuration. See Id., clause 9.2.3.2.1 of 3GPP TS 38.300.
The details of RRM configuration are the same type as specified for NR in clause 9.2.3.2.1 of 3GPP TS 38.300 including beam measurement information for the listed cells if the measurements are available. Id.
Radio resources are prepared in the target RAT before the handover.
The RRC reconfiguration message from the target RAT is delivered to the source RAT via a transparent container, and is passed to the UE by the source RAT in the handover command:
The inter-RAT handover command message carries the same type of information required to access the target cell as specified for NR baseline handover in clause 9.2.3.2.1 of 3GPP TS 38.300. Id.
The in-sequence and lossless handover is supported for the handover between the next generation Node B (gNB) and next generation evolved Node B (ng-eNB).
Both Xn and NG based inter-RAT handover between Next Generation Radio Access Network (NG-RAN) nodes is supported. Whether the handover is over Xn or CN is transparent to the UE.

In 3GPP TSs 38.413 and 36.413, when an inter-RAT handover is being prepared, a transparent container from Source to Target NG-RAN gets created from the source NG-RAN node. See 3GPP TS 36.413 v16.6.0, Technical Specification Group Radio Access Network, Evolved Universal Terrestrial Radio Access Network (E-UTRAN), S1 Application Protocol (S1AP) (Release 16), 07-2021 (Hereinafter “TS 36.413”); 3GPP TS 38.413 v16.6.0, Technical Specification Group Radio Access Network, NG-RAN, NG Application Protocol (Release 16), 07-2021 (Hereinafter “TS 38.413”). The details are listed in Annex A of TS 36.413. See TS 36.413, “Table A. 1. Specification of Transparent Containers referenced in SAP.”

Taking the case of inter-RAT system handover from Evolved Packet System (EPS) to 5th Generation System (5GS) as an example, section 8.4.1.2 of TS 36.413 states the following “ . . . if the handover is to NG-RAN, the information in the Source to Target Transparent Container Information Element (IE) shall be encoded according to the Source NG-RAN Node to Target NG-RAN Node Transparent Container IE definition as specified in TS 38.413.” The Target to Source Transparent Container IE is defined as follows in S1AP (TS 36.413):

### ***** Begin TS 36.413 Sections 9.2.1.56 *****

9.2.1.56 Source To Target Transparent Container
The Source to Target Transparent Container IE is an information element
that is used to transparently pass radio related information from the
handover source to the handover target through the EPC; it is produced
by the source RAN node and is transmitted to the target RAN node.

| IE/Group | | | IE type and | |
|---|---|---|---|---|
| Name | Presence | Range | reference | Semantics description |
| Source to | M | | OCTET | This IE includes a transparent |
| Target | | | STRING | container from the source RAN |
| Transparent | | | | node to the target RAN node. |
| Container | | | | The octets of the OCTET |
| | | | | STRING are encoded |
| | | | | according to the specifications |
| | | | | of the target system. |
| | | | | Note: in the current version of |
| | | | | the specification, this IE may |
| | | | | either carry the Source eNB to |
| | | | | Target eNB Transparent |
| | | | | Container IE or the Source |
| | | | | RNC to Target RNC |
| | | | | Transparent Container IE as |
| | | | | defined in TS 25.413 [19] or |
| | | | | the Source BSS to Target BSS |
| | | | | Transparent Container |
| | | | | Contents of the Source BSS to |
| | | | | Target BSS Transparent |
| | | | | Container IE as defined in TS |
| | | | | 48.018 [18] or the Old BSS to |
| | | | | New BSS information |
| | | | | elements field of the Old BSS |
| | | | | to New BSS information IE as |
| | | | | defined in TS 48.008 [23], or |
| | | | | the Source NG-RAN Node to |
| | | | | Target NG-RAN Node |
| | | | | Transparent Container IE as |
| | | | | defined in TS 38.413 [44]. |

### ***** End TS 36.413 Sections 9.2.1.56 *****

The above container content is encoded according to the rules which are specified for the target radio system. For our inter-RAT handover from EPS to 5GS example, the source evolved Node B (eNB) node must adapt to the target NG-RAN node RAT and its requirements. Therefore, the eNB produces this transparent container as a “source NG-RAN to target NG-RAN container” as defined in NGAP (TS 38.413) below:

### ***** Start TS 38.413 Sections 9.3.1.29 *****

9.3.1.29 Source NG-RAN Node to Target NG-RAN Node Transparent Container
This IE is produced by the source NG-RAN node and is transmitted to the target NG-RAN node.
For inter-system handovers to 5G, the IE is transmitted from
the external handover source to the target NG-RAN node.
This IE is transparent to the 5GC.

| | | | IE type and | Semantics | | Assigned |
|---|---|---|---|---|---|---|
| IE/Group Name | Presence | Range | reference | description | Criticality | Criticality |
| RRC Container | M | | OCTET STRING | Includes the RRC | — | |
| | | | | HandoverPrepa- | | |
| | | | | rationInformation | | |
| | | | | message as | | |
| | | | | defined in TS | | |
| | | | | 38.331 [18] if the | | |
| | | | | target is a gNB. | | |
| | | | | Includes the RRC | | |
| | | | | HandoverPrepa- | | |
| | | | | rationInformation | | |
| | | | | message as | | |
| | | | | defined in TS | | |
| | | | | 36.331 [21] if the | | |
| | | | | target is an ng- | | |
| | | | | eNB. | | |
| PDU Session Resource | | 0 . . . 1 | | For intra-system | — | |
| Information List | | | | handovers in NG- | | |
| | | | | RAN. | | |
| >PDU Session | | 1 . . . | | | — | |
| Resource Information | | <maxnoofPDUSessions> | | | | |
| Item | | | | | | |
| >>PDU Session ID | M | | 9.3.1.50 | | — | |
| >>QoS Flow | | 1 | | | — | |
| Information List | | | | | | |
| >>>QoS Flow | | 1 . . . | | | — | |
| Information Item | | <maxnoofQoSFlows> | | | | |
| >>>>QoS Flow | M | | 9.3.1.51 | | — | |
| Identifier | | | | | | |
| >>>>DL Forwarding | O | | 9.3.1.33 | | — | |
| >>>>UL Forwarding | O | | 9.3.1.118 | | YES | reject |
| >>DRBs to QoS Flows | O | | 9.3.1.34 | | — | |
| Mapping List | | | | | | |
| E-RAB | | 0 . . . 1 | | For inter-system | — | |
| Information List | | | | handovers to 5G. | | |
| >E-RAB Information | | 1 . . . | | | — | |
| Item | | <maxnoofE-RABS> | | | | |
| >>E-RAB ID | M | | 9.3.2.3 | | — | |
| >>DL Forwarding | O | | 9.3.1.33 | | — | |
| Target Cell ID | M | | NG-RAN CGI | | — | |
| | | | 9.3.1.73 | | | |
| Index to RAT/ | O | | 9.3.1.61 | | — | |
| Frequency | | | | | | |
| Selection Priority | | | | | | |
| UE History Information | M | | 9.3.1.95 | | — | |
| SgNB UE X2AP ID | O | | 9.3.1.127 | Allocated at the | — | |
| | | | | Source en-gNB | | |
| UE History Information | O | | 9.3.1.166 | | YES | ignore |
| from UE | | | | | | |

| Range bound | Explanation |
|---|---|
| maxnoofPDUSessions | Maximum no. of PDU sessions allowed towards one UE. Value is 256. |
| maxnoofQoSFlows | Maximum no. of QoS flows allowed within one PDU session. Value is 64. |
| maxnoofE-RABs | Maximum no. of E-RABs allowed towards one UE. Value is 256. |

### ***** End TS 38.413 Section 9.3.1.29 *****

As demonstrated above, the eNB will have to encode the transparent container with NR RRC information as in 3GPP TS 38.331 format for the target NR gNB. See 3GPP TS 38.331 v16.5.0, Technical Specification Group Radio Access Network, NR RRC Protocol Specification (Release 16), 06-2021 (Hereinafter “TS 38.331”). From the NR RRC Container HandoverPreparationInformation message defined in 3GPP TS 38.331, it is demonstrated that it contains the UE RAT capability. For example, see the below excerpt from TS 38.331:

```
    ***** START EXCERPT FROM 3GPP TS 38.331 *****
HandoverPreparationInformation-IEs ::= SEQUENCE {
  ue-CapabilityRAT-List UE-CapabilityRAT-ContainerList,
  sourceConfig AS-Config OPTIONAL, -- Cond HO
  rrm-Config RRM-Config OPTIONAL,
  as-Context AS-Context OPTIONAL,
  nonCriticalExtension SEQUENCE { } OPTIONAL
}
    ***** END EXCERPT FROM 3GPP TS 38.331 *****
```

For Xn-based handover, from an eNB connected to 5GC (ng-eNB) to gNB, a similar principle takes place where the source ng-eNB encodes the RRC message to signal over Xn following the target RAT requirements. See TS 38.423, section 9.1.1.1.

FIG. 1 illustrates an example of an architecture for inter-RAT handover from an eNB/ng-eNB to a gNB (or en-gNB).

### SUMMARY

Systems and methods are disclosed for signaling Reduced Capability (RedCap) wireless communication device (WCD) capability during inter-Radio Access Technology (RAT) handover. In one embodiment, a method performed by a target network node for inter-RAT handover of a WCD from a source network node of a first RAT to the target network node of a second RAT comprises receiving, at the target network node, a message in association with preparation or execution of a handover of a WCD from the source network node of the first RAT to the target network node of the second RAT, the message comprising information about one or more capabilities of the WCD. The method further comprises determining that the WCD is a RedCap WCD based on the information about the one or more capabilities of the WCD and sending an indication that the WCD is a RedCap WCD to a core network node. In this manner, RedCap WCD indication is provided during an inter-RAT handover.

In one embodiment, receiving the message comprises receiving the message from another network node during preparation for the handover of the WCD from the source network node to the target network node. In one embodiment, the message comprises a transparent container information element that comprises the information about the one or more capabilities of the WCD. In one embodiment, the information comprised in the transparent container information element is transparent to one or more network nodes through which the transparent container propagated from the source network node to the target network node. In one embodiment, the other network node is the core network node.

In one embodiment, the message comprising the information about the one or more capabilities of the WCD is a Handover Request message, and sending the indication that the WCD is a RedCap WCD to the core network node comprises sending a Handover Request Acknowledge message to the core network node, the Handover Request Acknowledge message comprising the indication that the WCD is a RedCap WCD.

In one embodiment, receiving the message comprises receiving the message during execution of the handover of the WCD from the source network node to the target network node. In one embodiment, receiving the message during execution of the handover of the WCD from the source network node to the target network node comprises receiving a message from the WCD comprising the information about one or more capabilities of the WCD. In another embodiment, receiving the message during execution of the handover of the WCD from the source network node to the target network node comprises receiving a Handover Confirm message from the WCD during execution of the handover of the WCD from the source network node to the target network node, the Handover Confirm message comprising the information about the one or more capabilities of the WCD. In one embodiment, sending the indication that the WCD is a RedCap WCD to the core network node comprises sending a Handover Notify message to the core network node, the Handover Notify message comprising the indication that the WCD is a RedCap WCD.

In one embodiment, sending the indication that the WCD is a RedCap WCD to the core network node comprises sending a N2 Path Switch Request message to the core network node, the N2 Path Switch Request message comprising the indication that the WCD is a RedCap WCD. In one embodiment, receiving the message that comprises the information about the one or more capabilities of the WCD comprises receiving a Handover Request message comprising handover preparation information, the handover preparation information comprising the information about the one or more capabilities of the WCD. In another embodiment, receiving the message that comprises the information about the one or more capabilities of the WCD comprises receiving a Radio Resource Control (RRC) Re-configuration Complete message from the WCD during execution of the handover, the RRC Re-configuration Complete message comprising the information about the one or more capabilities of the WCD. In another embodiment, receiving the message that comprises the information about the one or more capabilities of the WCD comprises receiving a dedicated random access preamble that indicates that the WCD is a RedCap WCD.

In one embodiment, the first RAT is Long Term Evolution (LTE), and the second RAT is New Radio (NR).

In one embodiment, the target network node is a NR base station (gNB), and the core network node is an Access and Mobility Management Function (AMF). In one embodiment, the source network node is an evolved Node B (eNB). In another embodiment, the source network node is a next generation evolved Node B (ng-eNB).

In one embodiment, the information about the one or more capabilities of the WCD comprises an explicit indication that the WCD is a RedCap WCD or the information about the one or more capabilities of the WCD comprises information that implicitly indicates that the WCD is a RedCap WCD.

Corresponding embodiments of a target network node are also disclosed. In one embodiment, a target network node for inter-RAT handover of a WCD from a source network node of a first RAT to the target network node of a second RAT is adapted to receive, at the target network node, a message in association with preparation or execution of a handover of a WCD from the source network node of the first RAT to the target network node of the second RAT, the message comprising information about one or more capabilities of the WCD. The target network node is further adapted to determine that the WCD is a RedCap WCD based on the information about the one or more capabilities of the WCD and send an indication that the WCD (206) is a RedCap WCD to a core network node.

In another embodiment, a target network node for inter-RAT handover of a WCD from a source network node of a first RAT to the target network node of a second RAT comprises one or more transmitters, one or more receivers, and processing circuitry. The processing circuitry is configured to cause the target network node to receive a message in association with preparation or execution of a handover of a WCD from the source network node of the first RAT to the target network node of the second RAT, the message comprising information about one or more capabilities of the WCD. The processing circuitry is further configured to cause the target network node to determine that the WCD is a RedCap WCD based on the information about the one or more capabilities of the WCD and send an indication that the WCD (206) is a RedCap WCD to a core network node.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example of an architecture for inter-Radio Access Technology (RAT) handover;

FIGS. 2A and 2B illustrate examples of a system architecture for inter-RAT handover of a wireless communication device (WCD) from a source network node of a first RAT to a target network node of a second RAT according to some embodiments of the present disclosure;

FIG. 3 illustrates Reduced Capability (RedCap) indication during a modified version of the inter-RAT handover preparation procedure described in 3rd Generation Partnership Project (3GPP) Technical Specification (TS) 23.502 according to one example embodiment of the present disclosure;

FIG. 4 illustrates RedCap capability indication during a modified version of the inter-RAT handover execution procedure described in 3GPP TS 23.502 according to one example embodiment of the present disclosure;

FIG. 5 illustrates another example embodiment in which a RedCap UE indication is provided either the inter-RAT handover;

FIG. 6 shows an example of a communication system in which embodiments of the present disclosure may be implemented;

FIG. 7 shows a User Equipment (UE), which is one example of a WCD, in accordance with some embodiments of the present disclosure;

FIG. 8 shows a network node in accordance with some embodiments of the present disclosure;

FIG. 9 is a block diagram of a host, which may be an embodiment of the host of FIG. 6, in accordance with various aspects described herein;

FIG. 10 is a block diagram illustrating a virtualization environment in which functions implemented by some embodiments may be virtualized; and

FIG. 11 shows a communication diagram of a host communicating via a network node with a UE over a partially wireless connection in accordance with some embodiments of the present disclosure.

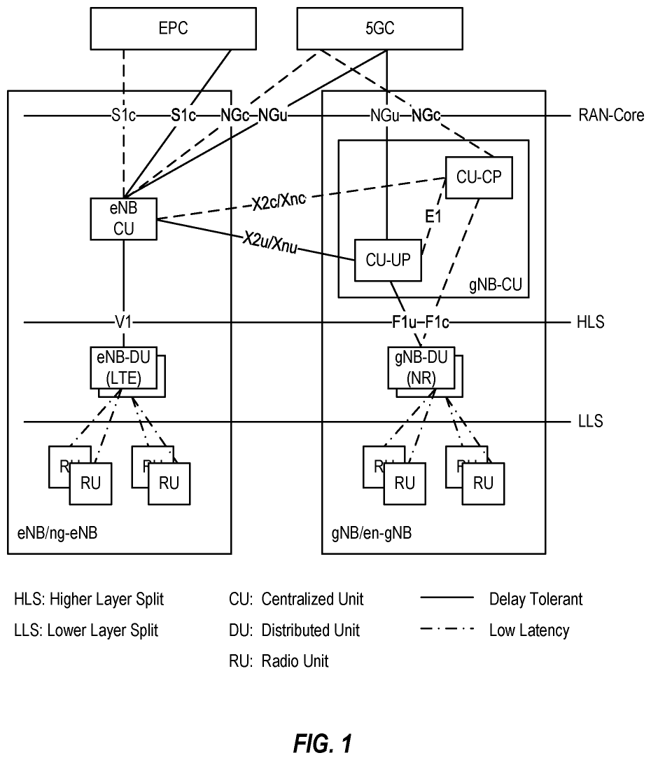

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Note that, as used herein, a “RedCap UE” or “RedCap WCD” is a User Equipment (UE) or wireless communication device (WCD) having reduced capabilities (e.g., reduced maximum bandwidth, reduced data rate, reduced minimum number of receive branches, reduced maximum number of downlink Multiple Input Multiple Output (MIMO) layers, reduced maximum downlink modulation order, and/or reduced number of options for duplexing mode of operation), as compared to a baseline UE or WCD (e.g., a 3rd Generation Partnership Project (3GPP) Release 15 UE).

There currently exist certain challenge(s). Specifically, it is currently assumed in the 3GPP RAN2 working group that inter-Radio Access Technology (RAT) mobility related capabilities are applicable for RedCap UEs, meaning that a RedCap UE can perform inter-RAT mobility from, e.g., Evolved Universal Terrestrial Radio Access (E-UTRA) to New Radio (NR). In the agreed SA2 Change Request (CR) in S2-2106979, an editor's note (EN) stipulates that “it is for further search how NR RedCap RAT Indication is provided during inter-system handover from EPS to 5GS.” S2-2106979, Section 5.x.x. When the NR RedCap UE accesses next generation Node B (gNB) over the NR Uu interface, the Access and Mobility Management Function (AMF) gets the NR RedCap UE indication over the NG-AP interface as described in the SA2 CR. The AMF can pass this indication explicitly to a target Core Network (CN), which can then use it for, e.g., charging and roaming policy.

However, when the RedCap UE accesses over the Long Term Evolution (LTE) Uu and handover to NR, it is not clear how the CN can receive the RedCap indication. In case of an Evolved Packet System (EPS) to 5th Generation System (5GS) inter-system handover, UE capability information needs to go through different hops as specified, namely, the specified hops are: evolved Node B (eNB)→Mobility Management Entity (MME)→AMF→gNB. An eNB (and MME) in principle does not understand NR capabilities. So, the question is how policy and charging/roaming control can be achieved at the target 5th Generation Core (5GC) when a RedCap UE performs inter-RAT handover from EPS to 5GS. The same question can be considered for Xn-based inter-RAT handover from next generation eNB (ng-eNB) to gNB which can be connected to the same AMF, or N2-based inter-RAT handover from ng-eNB to gNB which are connected to different AMFs.

Certain aspects of the disclosure and their embodiments may provide solutions to these or other challenges. Specifically, in one embodiment, using the existing framework of inter-RAT handovers in NG-AP and XnAP specifications, it is proposed to add new NR RedCap indications to signal from target RAN to target AMF that the resources being prepared/allocated for the Handover are for a NR RedCap UE. In one embodiment, the UE indicates to the target cell that it is a RedCap UE using a Radio Resource Control (RRC) reconfiguration complete message or its Medium Access Control (MAC) header, or a preamble (dedicated or selected from a configured set to indicate that the UE is a RedCap UE intended for initial access), or a Physical Random Access Channel (PRACH) resource (dedicated or selected from a configured set to indicate that the UE is a RedCap UE intended for initial access) during E-UTRA to NR handover.

Embodiments of solutions disclosed herein provide a method for the 5GC to identify the RedCap UE during E-UTRA/LTE to NR handover and apply proper control in the 5GC as early as possible. The identification and formulation of the RedCap indication at the target gNB during inter-RAT system HO can be as follows.

In one embodiment, during inter-RAT handover of a UE from a source eNB or ng-eNB to a target gNB, the target gNB signals information to a core network node (e.g., AMF) that indicates that the UE is a RedCap UE based on UE capability information received by the target gNB, e.g., in an RRC handover transport container, from the source eNB/ng-eNB via messages exchanged during the inter-RAT handover.

In one embodiment, from Next Generation (NG)-based inter-RAT handover messages, a new indication of NR RedCap UE is added in the NG-AP HANDOVER REQUEST ACKNOWLEDGE or HANDOVER NOTIFY message from the target gNB towards the AMF, so that the 5GC can take this information into account. In one embodiment, the signaling of this indication follows after the target gNB inspects the received RRC transport container over the NG interface and identifies, either explicitly or implicitly, the redcap UE information within it. In one embodiment, in case of rejection, a new cause value is defined to inform the target gNB of the handover cancellation cause

In one embodiment, from Xn-based inter-RAT system handover, for Xn handover from a source ng-eNB to the target gNB, a new indication is added in the NG-AP PATH SWITCH REQUEST message from the target gNB to the AMF, so that the 5GC can be aware of the UE being a RedCap UE and take the information into account, e.g., decide to either proceed with the N3 tunnel setup or reject the path switch request. In one embodiment, the signaling of this indication follows after the target gNB inspects the received RRC transport container over Xn interface and identifies, either explicitly or implicitly, the redcap UE information within it. In on embodiment, in case of rejection, a new cause value is defined to inform the target gNB of the path switch request failure cause. The target gNB can also signal this cause value to the source ng-eNB.

In one embodiment, the target gNB may also convey the information to the core network that indicates that the UE is a RedCap UE based on the indication or UE capability information directly received from the UE during the execution phase of the inter-RAT handover procedure explicitly, e.g., as part of the RRC re-configuration complete message.

Certain embodiments may provide one or more of the following technical advantage(s). Specifically, present embodiments provide missing support of RedCap UE indications during inter-RAT handovers. For example, present embodiments provide support for RedCap UE indications during inter-RAT Handovers from E-UTRA to NR.

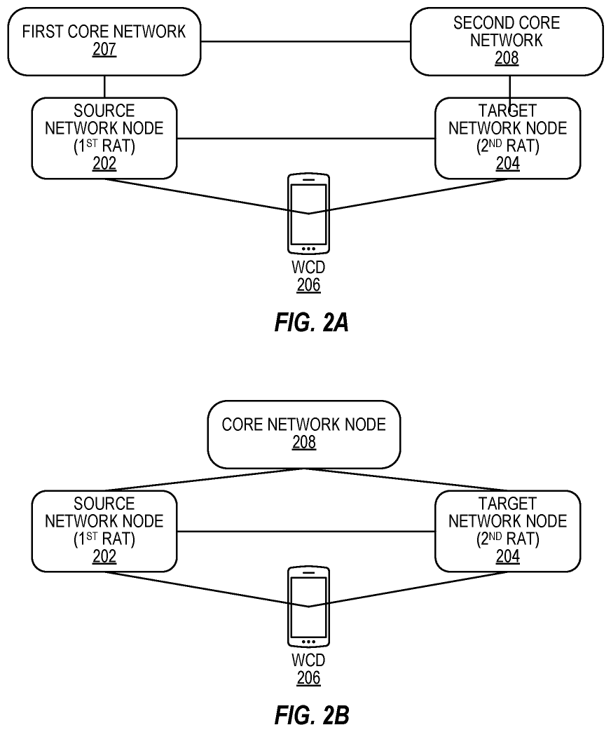

FIG. 2A illustrates a system architecture for inter-RAT handover of a wireless communication device (WCD) 206 (e.g., a UE) from a source network node 202 (e.g., eNB) of a first RAT (e.g., E-UTRA) associated with a first core network 207 (e.g., EPC) to a target network node 204 (e.g., gNB) of a second RAT (e.g., NR) associated with a second core network 208 (e.g., 5GC) according to some embodiments of the present disclosure.

Specifically, the target network node 204 receives a message in association with preparation or execution of a handover of the WCD 206 from the source network node 202 of the first RAT to the target network node 204 of the second RAT. The message can include information about one or more capabilities of the WCD 206. The target network node 204 determines that the WCD 206 is a Reduced Capability (RedCap) WCD based on the information about the one or more capabilities of the WCD 206. The target network node 204 sends an indication that the WCD 206 is a RedCap WCD to a core network node (e.g., AMF) in the second core network 208.

In some embodiments, receiving the message comprises receiving the message from another network node during preparation for the handover of the WCD 206 from the source network node 202 to the target network node 204.

In some embodiments, the message received by the target network node 204 comprises a transparent container information element that comprises the information about the one or more capabilities of the WCD 206.

In some embodiments, the information comprised in the transparent container information element is transparent to one or more network nodes through which the transparent container propagated from the source network node 202 to the target network node 204.

In some embodiments, the message comprising the information about the one or more capabilities of the WCD 206 is a Handover Request message, and sending the indication that the WCD 206 is a RedCap WCD to the core network node in the second core network 208 comprises sending a Handover Request Acknowledge message to the core network node. The Handover Request Acknowledge message comprises the indication that the WCD 206 is a RedCap WCD.

In some embodiments, receiving the message comprising the information about the one or more capabilities of the WCD 206 at the target network node 204 comprises receiving the message at the target network node 204 from the core network node (e.g., AMF) in the second core network 208.

In some embodiments, receiving the message at the target network node 204 comprises receiving the message at the target network node 204 during execution of the handover of the WCD 206 from the source network node 202 to the target network node 204.

In some embodiments, receiving the message at the target network node 204 during execution of the handover of the WCD 206 from the source network node 202 to the target network node 204 comprises receiving a Handover Confirm message from the WCD 206 during execution of the handover of the WCD 206 from the source network node 202 to the target network node 204. The Handover Confirm message comprises the information about the one or more capabilities of the WCD 206.

In some embodiments, sending the indication that the WCD 206 is a RedCap WCD from the target network node 204 to the core network node in the second core network 208 comprises sending a Handover Notify message to the core network node, the Handover Notify message comprising the indication that the WCD 206 is a RedCap WCD.

In some embodiments, sending the indication that the WCD 206 is a RedCap WCD from the target network node 204 to the core network node in the second core network 208 comprises sending a N2 Path Switch Request message from the target network node 204 to the core network node, the N2 Path Switch Request message comprising the indication that the WCD 206 is a RedCap WCD.

In some embodiments, receiving the message that comprises the information about the one or more capabilities of the WCD 206 at the target network node 204 comprises receiving a Handover Request message comprising handover preparation information, the handover preparation information comprising the information about the one or more capabilities of the WCD 206.

In some embodiments, receiving the message that comprises the information about the one or more capabilities of the WCD 206 at the target network node 204 comprises receiving a RRC Re-configuration Complete message from the WCD 206 during execution of the handover. The RRC Re-configuration Complete message comprises the information about the one or more capabilities of the WCD 206.

In some embodiments, receiving the message that comprises the information about the one or more capabilities of the WCD 206 at the target network node 204 comprises receiving a dedicated random access preamble that indicates that the WCD 206 is a RedCap WCD.

In some embodiments, the first RAT of the source network node 202 is E-UTRA (also referred to herein as “LTE”) and the second RAT of the target network node 204 is New Radio (NR). For example, the source network node can provide radio access to the WCD 206 utilizing E-UTRA, and the target network node 204 can provide radio access to the WCD 206 utilizing NR.

In some embodiments, the target network node 204 is a gNB, and the core network node is an Access and Mobility Management Function (AMF).

In some embodiments, (a) the information about the one or more capabilities of the WCD 206 comprises an explicit indication that the WCD 206 is a RedCap WCD, or (b) the information about the one or more capabilities of the WCD 206 comprises information that implicitly indicates that the WCD (206) is a RedCap WCD.

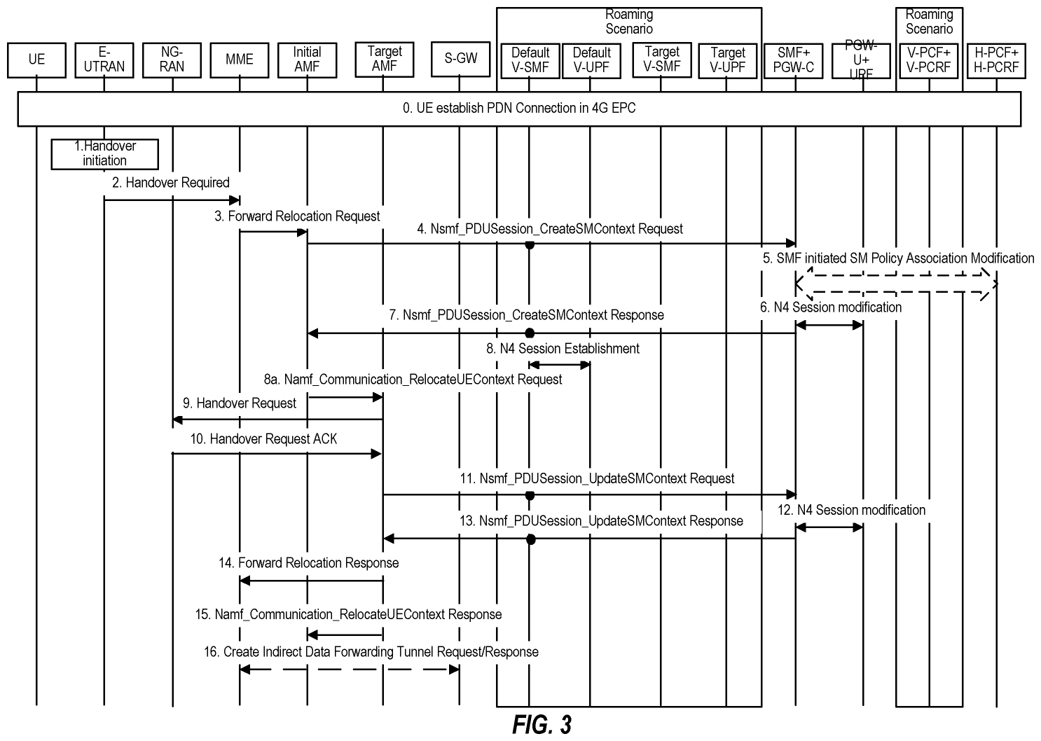

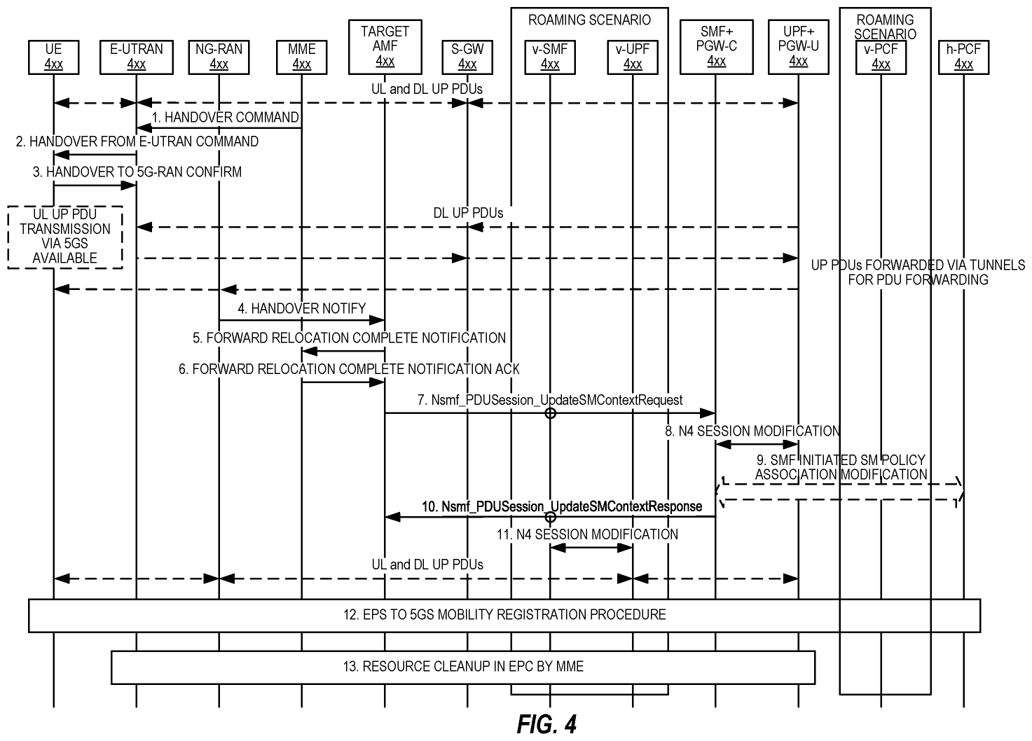

Now, a description is provided of some example embodiments in which the first RAT of the source network node 202 is E-UTRA and the second RAT of the target network node 204 is NR. In this case, the source network node 202 is, for these example embodiments, an eNB, the first core network 207 is an EPC, the target network node 204 is a gNB, and the second core network 208 is a 5GC. In this regard, FIGS. 3 and 4 illustrate example embodiments in which the aforementioned RedCap UE indication is provided either during the inter-RAT handover preparation phase (FIG. 3) or during the inter-RAT handover execution phase (FIG. 4). In these scenarios, the inter-RAT handover can be referred to as an “NG-based inter-RAT handover”.

FIG. 3 illustrates RedCap capability indication during a modified version of the inter-RAT handover preparation procedure described in 3GPP TS 23.502 (see, e.g., Figure 4.11.1.2.2.2-1 of TS 23.502 and the associated text), according to one example embodiment of the present disclosure. The details of many of the steps of the procedure of FIG. 3 are the same as that described in 3GPP TS 23.502 and, as such, the following description of FIG. 3 focuses on the modifications to the inter-RAT handover preparation procedure in accordance with an embodiment of the present disclosure. Specifically, FIG. 3 depicts that a RedCap indication can be added in step 10 of FIG. 3 during the inter-RAT handover preparation phase. For example, at step 9 of FIG. 3, the target Access and Mobility Management Function (AMF) sends a Handover Request (Source to Target Transparent Container, Allowed Network Slice Assistance Information (NSSAI), Protocol Data Unit (PDU) session identifier (ID), and the Single NSSAI (S-NSSAI) received from Source AMF associated with the corresponding N2 Session Management (SM) Information (Quality of Service (QOS) Flow ID(s) (QFI(s)), QOS Profile(s), EPS Bearer Setup List, visited core network (V-CN) Tunnel Info, Mapping between EPS bearer ID(s) (EBI(s)) and QFI(s)), Mobility Restriction List, UE Radio Capability ID) message to the NG-RAN (i.e., to the target gNB). The target AMF provides the Next Generation Radio Access Network (NG-RAN) with a Public Land Mobile Network (PLMN) list in the Mobility Restriction List containing at least the serving PLMN, taking into account the last used EPS PLMN ID and the Return preferred indication. The Mobility Restriction List contains information about PLMN IDs as specified by 3GPP TS 23.501. Importantly, in one embodiment, the UE capability information for the UE being handed over is included in the Source to Target Transparent Container included in the Handover Request.

The NG-RAN (i.e., the target gNB) can use the source to target transparent container contained in the Handover Request received from the target AMF and N2 SM Information container to determine which QoS flows have been proposed for forwarding and decide for which of those QoS flows it accepts the data forwarding or not.

The target AMF provides the UE Radio Capability ID to the NG-RAN (i.e., to the target gNB) if Radio Capability Signaling (RACS) is supported. If the UE Radio Capability ID is included in the Handover Request message, when there is no corresponding UE radio capabilities set for UE Radio Capability ID at the NG-RAN and no UE radio access capabilities are provided in the Source to Target transparent container, the NG-RAN requests the target AMF (T-AMF) to provide the UE radio capabilities set corresponding to UE Radio Capability ID to the NG-RAN. If the Source to Target transparent container contains the UE radio access capabilities and the T-RAN did not receive the UE Radio Capability ID from the T-AMF, the NG-RAN proceeds with handover using the received UE access radio capabilities. If the T-RAN received both the UE radio access capabilities and the UE Radio Capability ID, then the T-RAN uses any locally stored UE radio access capability information corresponding to the UE Radio Capability ID. If none are stored locally, the T-RAN may request the full UE radio access capability information from the core network. If the full UE radio access capability information is not promptly received from the core network, or the T-RAN chooses not to request them, then the T-RAN proceeds with the UE radio access capabilities sent by the source RAN node. The T-RAN does not use the UE radio access capability information received from the source RAN node for any other UE with the same the UE Radio Capability ID.

At step 10 of FIG. 3, the NG-RAN (i.e., the target gNB) sends a Handover Request Acknowledge (Target to Source Transparent Container, List of PDU Sessions to Hand-over with N2 SM response (PDU Session ID, list of accepted QFI(s), Access Network (AN) Tunnel Info, Data Forwarding Tunnel Info), List of PDU Sessions that failed to be established with the failure cause given in the N2 SM information element, RedCap Indication) message to the target AMF. Note that, in one embodiment, the NG-RAN (i.e., the target gNB) determines whether the UE is a NR RedCap UE based on the information about the UE capabilities, e.g., contained in the Source to Target Transparent Container included in the Handover Request received from the target AMF in step 9. This information about the UE capabilities may include information that explicitly indicates that the UE is a RedCap UE or information that implicitly indicates that the UE is a RedCap UE.

If indirect data forwarding is applied, the NG-RAN includes one assigned Tunneling Endpoint ID (TEID)/Transport Network Layer (TNL) address per PDU Session (for which there is at least one QoS flow for which it has accepted the forwarding) within the SM Info container. It also includes the list of QoS flows for which it has accepted the forwarding. According to the mapping between EBI(s) and QFI(s), if one EPS bearer in EPS is mapped to multiple QoS flows in 5GS, all such QoS flows need to be accepted to support indirect data forwarding during EPS to 5GS mobility. Otherwise, the NG RAN rejects the indirect data forwarding for the QoS flows which are mapped to the EPS bearer.

If direct data forwarding is applied, the NG-RAN includes one assigned TEID/TNL per E-UTRAN RAB (E-RAB) accepted for direct data forwarding.

When the target NG-RAN rejects the handover with a Handover Failure, steps 11-13 and step 16 of FIG. 3 are not executed.

As such, the NG-RAN (i.e., target gNB) may provide a RedCap Indication in the message if NG-RAN realizes the UE is RedCap UE based on the RRC container in the Source to Target Transparent Container IE provided in step 9.

Thus, in some embodiments, an inter-RAT handover for a NR redcap UE is being prepared from EPS to 5GS (see, e.g., FIG. 3), where a S1 Handover Required message is initiated from the source eNB to the MME that is connected to target AMF. During the preparation phase, the target gNB receives from the AMF the Source to Target Transparent Container IE in the NG-AP HANDOVER REQUEST message.
In some embodiments, the target gNB, upon inspection of the NR RRC transparent container, realizes that the UE RAT Capabilities correspond explicitly to a NR RedCap UE. This can be through an explicit RedCap indication defined in the UE RAT Capabilities within the RRC container. The target gNB then formulates a new NR RedCap indication and signals this new indication to the AMF in the NG-AP HANDOVER REQUEST ACKNOWLEDGE message at step 10 of FIG. 3.
In some alternative embodiments, the target gNB, upon inspection of the NR RRC container, realizes that the UE RAT Capabilities correspond implicitly to a NR RedCap UE. This can be through implicit indications of, e.g., the supported bandwidths and number of Multiple Input Multiple Output (MIMO) layers. The target gNB then formulates a new NR RedCap indication and signals this new indication to the AMF in the NG-AP HANDOVER REQUEST ACKNOWLEDGE message at step 10 of FIG. 3.
As an example, the below handover request acknowledge can be sent by the target NG-RAN node to inform the AMF about the prepared resources at the target, in the direction of NG-RAN node→AMF:

### Handover Request Acknowledge

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | reject |
| AMF UE NGAP ID | M | | 9.3.3.1 | | YES | ignore |
| RAN UE NGAP ID | M | | 9.3.3.2 | Allocated at the | YES | ignore |
| | | | | target NG-RAN | | |
| | | | | node. | | |
| PDU Session Resource | | 1 | | | YES | ignore |
| Admitted List | | | | | | |
| >PDU Session | | 1 . . . | | | — | |
| Resource Admitted | | <maxnoofPDUSessions> | | | | |
| Item | | | | | | |
| >>PDU Session ID | M | | 9.3.1.50 | | — | |
| >>Handover Request | M | | OCTET | Containing the | — | |
| Acknowledge | | | STRING | Handover Request | | |
| Transfer | | | | Acknowledge | | |
| | | | | Transfer IE | | |
| | | | | specified in | | |
| | | | | subclause | | |
| | | | | 9.3.4.11. | | |
| PDU Session Resource | | 0 . . . 1 | | | YES | ignore |
| Failed to Setup List | | | | | | |
| >PDU Session | | 1 . . . | | | — | |
| Resource Failed to | | <maxnoofPDUSessions> | | | | |
| Setup Item | | | | | | |
| >>PDU Session ID | M | | 9.3.1.50 | | — | |
| >>Handover | M | | OCTET | Containing the | — | |
| Resource Allocation | | | STRING | Handover | | |
| Unsuccessful | | | | Resource | | |
| Transfer | | | | Allocation | | |
| | | | | Unsuccessful | | |
| | | | | Transfer IE | | |
| | | | | specified in | | |
| | | | | subclause | | |
| | | | | 9.3.4.19. | | |
| Target to Source | M | | 9.3.1.21 | | YES | reject |
| Transparent Container | | | | | | |
| Criticality Diagnostics | O | | 9.3.1.3 | | YES | ignore |
| RedCap Identification | O | | Enumerated(‘true’ . . . ) | | YES | ignore |

| Range bound | Explanation |
|---|---|
| maxnoofPDUSessions | Maximum no. of PDU sessions allowed towards one UE. Value is 256. |

As another example, the below handover notify message can be sent by the target NG-RAN node (i.e., the target gNB) to inform the AMF that the UE has been identified in the target cell and the handover has been completed in the direction of NG-RAN node AMF:

### Handover Notify

| | | | | | | |
|---|---|---|---|---|---|---|
| | | | IE type and | Semantics | | Assigned |
| IE/Group Name | Presence | Range | reference | description | Criticality | Criticality |

| | | | | |
|---|---|---|---|---|
| Message Type | M | 9.3.1.1 | YES | ignore |
| AMF UE NGAP ID | M | 9.3.3.1 | YES | reject |
| RAN UE NGAP ID | M | 9.3.3.2 | YES | reject |
| User Location | M | 9.3.1.16 | YES | ignore |
| Information | | | | |
| Notify Source NG-RAN | O | ENUMERATED | YES | ignore |
| Node | | (NotifySource, . . . ) | | |
| RedCap Identification | O | Enumerated(‘true’ . . . ) | YES | ignore |

FIG. 4 illustrates RedCap capability indication during a modified version of the inter-RAT handover execution procedure described in 3GPP TS 23.502 (see, e.g., Figure 4.11.1.2.2.3-1 of TS 23.502 and the associated text), according to one example embodiment of the present disclosure. The details of many of the steps of the procedure of FIG. 4 are the same as that described in 3GPP TS 23.502 and, as such, the following description of FIG. 4 focuses on the modifications to the inter-RAT handover execution procedure in accordance with an embodiment of the present disclosure. Specifically, at step 3 of FIG. 4, the UE confirms handover to the NG-RAN (i.e., to the target gNB), and the UE moves from the E-UTRAN and synchronizes with the target NG-RAN. The UE may also include a RedCap Indication to the NG-RAN (i.e., to the target gNB) if the UE is a RedCap UE. The UE may resume the uplink transmission of user plane data only for those QFIs and Session IDs for which there are radio resources allocated in the NG-RAN.

The Evolved Universal Terrestrial Radio Access Network (E-UTRAN) sends downlink (DL) data to the Data Forwarding address received in step 1 of FIG. 4. If the indirect data forwarding is applied, the E-UTRAN forward the DL data to NG-RAN via the Serving Gateway (SGW) and the visited User Plane Function (v-UPF). The v-UPF forwards the data packets to the NG-RAN using the N3 Tunnel Info for data forwarding, adding the QFI information. The target NG-RAN prioritizes the forwarded packets over the fresh packets for those QoS flows for which it had accepted data forwarding. If direct data forwarding is applied, the E-UTRAN forwards the DL data packets to the NG-RAN via the direct data forwarding tunnel.

At step 4 of FIG. 4, the NG-RAN (i.e., the target gNB) notifies to the target AMF that the UE is handed over to the NG-RAN. The NG-RAN (i.e., the target gNB) may also provide a RedCap Indication in the message if NG-RAN realizes the UE is RedCap UE based on UE provided RedCap Indication in step 3 above or RRC container information received during handover preparation phase.

Thus, in some embodiments, the target gNB may receive a RedCap indication directly from the UE in step 3 of FIG. 4, as part of the message sent to confirm handover to 5G-RAN. The indication can be provided using the RRC reconfiguration complete message (see example below) or its MAC header (see example below). Upon receiving such indication, gNB conveys to the AMF in HO NOTIFY message (step 4 of FIG. 4) that the UE is a RedCap UE. In a first option, indication via RRC reconfiguration complete message can be captured, for example, by introducing a new parameter in the message given below. See TS 38.331. Note that this is just an example showing how such parameter can be specified as part of the RRC message, but it is not the only way. In some embodiments, to convey such information a dedicated preamble indicated by the network can be used as part of the handover command or selected from a set of preambles that are configured to indicate that the UE is a RedCap UE prior to triggering access to the target gNB. The preambles can be RedCap-specific preambles configured to be used when triggering access to the target gNB within a shared RACH occasion (RO), e.g., with any other UE types such as “normal” UEs, or preambles to be used in a RACH occasion dedicated for RedCap UEs, e.g. when a separate bandwidth part (BWP) is configured for RedCap UEs. The preambles can also be preambles that are configured for RedCap UEs to be used when triggering initial access to the network. The configuration related to how UE indicates being a RedCap UE, e.g. information on which dedicated preamble or RO is to be used can be provided as part of the handover command conveyed to the UE via the source eNB.

As mentioned above, for one example, the below RRCReconfigurationComplete message is used to confirm the successful completion of an RRC connection reconfiguration.

```
      Example RRCReconfigurationComplete Message
      Signaling radio bearer: SRB1 or SRB3; RLC-SAP: AM; Logical channel: DCCH;
Direction: UE to network:
      RRCReconfigurationComplete Message
-- ASN1START
-- TAG-RRCRECONFIGURATIONCOMPLETE-START
```

| | |
|---|---|
| RRCReconfigurationComplete ::= | SEQUENCE { |
| rrc-TransactionIdentifier | RRC-TransactionIdentifier, |
| criticalExtensions | CHOICE { |
| rrcReconfigurationComplete | RRCReconfigurationComplete-IEs, |
| criticalExtensionsFuture | SEQUENCE { } |

}
}

| | |
|---|---|
| RRCReconfigurationComplete-IEs ::= | SEQUENCE { |
| lateNonCriticalExtension | OCTET STRING |

OPTIONAL,

| | |
|---|---|
| nonCriticalExtension | RRCReconfigurationComplete-v1530-IEs |

OPTIONAL
}

| | |
|---|---|
| RRCReconfigurationComplete-v1530-IEs ::= | SEQUENCE { |
| uplinkTxDirectCurrentList | UplinkTxDirectCurrentList |

OPTIONAL,

| | |
|---|---|
| nonCriticalExtension | RRCReconfigurationComplete-v1560-IEs |

OPTIONAL
}

| | |
|---|---|
| RRCReconfigurationComplete-v1560-IEs ::= | SEQUENCE { |
| scg-Response | CHOICE { |
| nr-SCG-Response | OCTET STRING (CONTAINING |

RRCReconfigurationComplete),

| | |
|---|---|
| eutra-SCG-Response | OCTET STRING |
| } | OPTIONAL, |
| nonCriticalExtension | RRCReconfigurationComplete-v1610-IEs |

OPTIONAL
}

| | |
|---|---|
| RRCReconfigurationComplete-v1610-IEs ::= | SEQUENCE { |
| ue-MeasurementsAvailable-r16 | UE-MeasurementsAvailable-r16 |

OPTIONAL,

| | |
|---|---|
| needForGapsInfoNR-r16 | NeedForGapsInfoNR-r16 |

OPTIONAL,

| | |
|---|---|
| nonCriticalExtension | RRCReconfigurationComplete-v1640-IEs |

OPTIONAL
}

| | |
|---|---|
| RRCReconfigurationComplete-v1640-IEs ::= | SEQUENCE { |
| uplinkTxDirectCurrentTwoCarrierList-r16 | UplinkTxDirectCurrentTwoCarrierList-r16 |

OPTIONAL,

| | |
|---|---|
| nonCriticalExtension | SEQUENCE { } |

OPTIONAL
}

| | |
|---|---|
| RRCReconfigurationComplete-r17-IEs ::= | SEQUENCE { |

UEType-r17 ENUMARATED {redCap, spare1, spare2, spare3}
OPTIONAL,

| | |
|---|---|
| nonCriticalExtension | SEQUENCE { } |

OPTIONAL
}
-- TAG-RRCRECONFIGURATIONCOMPLETE-STOP
-- ASN1STOP

RRCReconfigurationComplete-IEs field descriptions

needForGapsInfoNR
This field is used to indicate the measurement gap requirement information
of the UE for NR target bands.
scg-Response
In case of NR-DC (nr-SCG-Response), this field includes the
RRCReconfigurationComplete message. In case of NE-DC (eutra-SCG-
Response), this field includes the E-UTRA
RRCConnectionReconfigurationComplete message as specified in
TS 36.331 [10].
uplinkTxDirectCurrentList
The Tx Direct Current locations for the configured serving cells and
BWPs if requested by the NW (see reportUplinkTxDirectCurrent in
CellGroupConfig).
uplinkTxDirectCurrentTwoCarrierList
The Tx Direct Current locations for the configured uplink intra-band CA
with two carriers if requested by the NW (see
reportUplinkTxDirectCurrentTwoCarrier-r16 in CellGroupConfig).

As mentioned above, for another example, this information can be conveyed by capturing the indication in the MAC header associated with the RRC reconfiguration complete message For example, the information can be conveyed by:
introduction of a new LCID from one of the reserved values in table 6.2.1-2 in the table (provided below)
reserved bit
a flag in one of the existing MAC CEs relevant when transmitting the PDSCH message that carries the RRC Re-configuration complete message or in a new MAC CE where the rest of the bits are reserved for future or shared with another functionality.

The following is the description of MAC subheader for DL-SCH and UL-SCH from TS 38.321:

*** Begin MAC Subheader Description from TS 38.321 ***

The MAC subheader consists of the following fields:
LCID: The Logical Channel ID field identifies the logical channel instance of the corresponding MAC SDU or the type of the corresponding MAC CE or padding as described in Tables 6.2.1-1 and 6.2.1-2 for the DL-SCH and UL-SCH respectively. There is one LCID field per MAC subheader. The LCID field size is 6 bits;
L: The Length field indicates the length of the corresponding MAC SDU or variable-sized MAC CE in bytes. There is one L field per MAC subheader except for subheaders corresponding to fixed-sized MAC CEs, padding, and MAC SDUs containing UL CCCH. The size of the L field is indicated by the F field;
F: The Format field indicates the size of the Length field. There is one F field per MAC subheader except for subheaders corresponding to fixed-sized MAC CEs, padding, and MAC SDUs containing UL CCCH. The size of the F field is 1 bit. The value 0 indicates 8 bits of the Length field. The value 1 indicates 16 bits of the Length field;
R: Reserved bit, set to 0.
   The MAC subheader is octet aligned.

TABLE 6.2.1-2
Values of LCID for UL-SCH

| Index | LCID values |
|---|---|
| 0 | CCCH of size 64 bits (referred to as |
| | “CCCH1” in TS 38.331 [5]) |
| 1-32 | Identity of the logical channel |
| 33-51 | Reserved |
| 52 | CCCH of size 48 bits (referred to as |
| | “CCCH” in TS 38.331 [5]) |
| 53 | Recommended bit rate query |
| 54 | Multiple Entry PHR (four octets Cᵢ) |
| 55 | Configured Grant Confirmation |
| 56 | Multiple Entry PHR (one octet Cᵢ) |
| 57 | Single Entry PHR |
| 58 | C-RNTI |
| 59 | Short Truncated BSR |
| 60 | Long Truncated BSR |
| 61 | Short BSR |
| 62 | Long BSR |
| 63 | Padding |

*** End MAC Subheader Description from TS 38.321 ***

Following this indication from the target gNB, the AMF decides to either proceed with the handover process or abort it. In case of abortion, the AMF, in a new embodiment, informs the source eNB of the reason of failure via MME and S1AP interface.

FIG. 2B illustrates a system architecture for inter-RAT handover of a WCD 206 from a source network node 202 (e.g., ng-eNB) of a first RAT (E-UTRA) associated with a core network 208 (e.g., 5GC) to a target network node 204 (e.g., gNB) of a second RAT (e.g., NR) associated with the same core network 208 according to some embodiments of the present disclosure. Specifically, unlike the system architecture described with regards to FIG. 2A, FIG. 2B describes an architecture in which the source network node 202 and the target network node 204 are both associated with the same core network node 208.

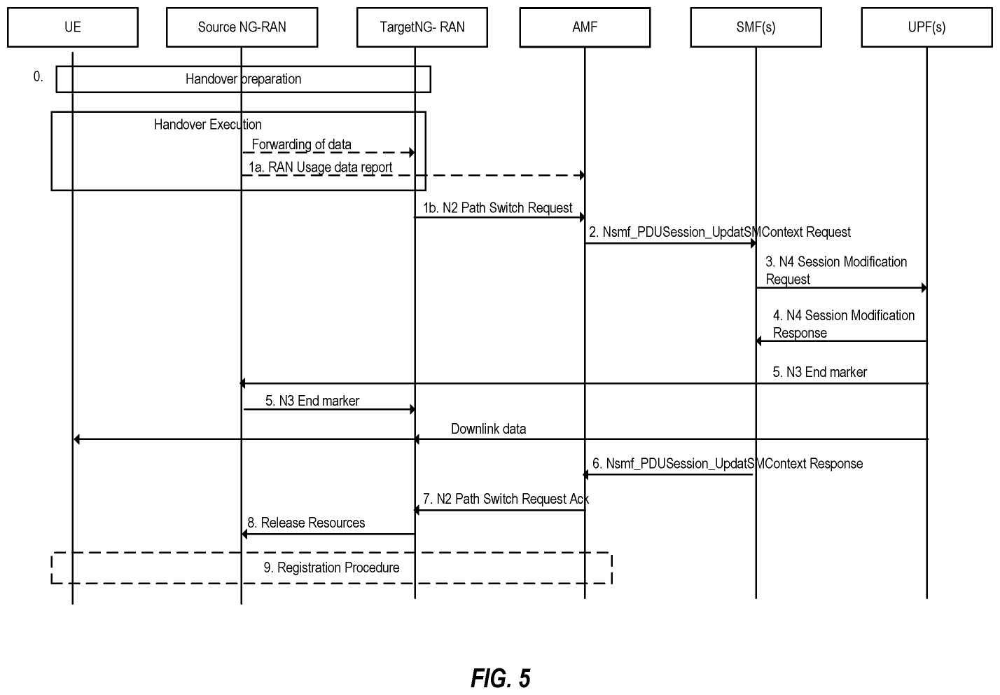

Now, a description is provided of some example embodiments in which the first RAT of the source network node 202 is E-UTRA and the second RAT of the target network node 204 is NR. In this case, the source network node 202 is for these example embodiments an ng-eNB, the core network 208 is a 5GC, and the target network node 204 is a gNB. In this regard, FIG. 5 illustrates an example embodiment in which the aforementioned RedCap UE indication is provided during the inter-RAT handover. In this scenario, the inter-RAT handover can be referred to as an “Xn-based inter-RAT handover”.

FIG. 5 illustrates RedCap capability indication during an Xn-based inter-RAT handover procedure. Note that the process of FIG. 5 is a modified version of the Xn-based inter-NG-RAN handover without User Plane function re-allocation described in 3GPP TS 23.502 (see, e.g., Figure 4.9.1.2.2-1 of TS 23.502 V17.2.0 and the associated text). The details of many of the steps of the procedure of FIG. 5 are the same as that described in 3GPP TS 23.502 and, as such, the following description of FIG. 5 focuses on the modifications to the inter-RAT handover procedure in accordance with an embodiment of the present disclosure. Specifically, in this embodiment, a RedCap Indication is added in step 1b of FIG. 5.

The procedure illustrated in FIG. 5 is used to hand over a UE from a source NG-RAN (e.g., source ng-eNB) to target NG-RAN (e.g., target gNB) using Xn when the AMF is unchanged and the Session Management Function (SMF) decides to keep the existing User Plane Function (UPF). The UPF referred here is the UPF which terminates N3 interface in the 5GC for non-roaming or local breakout roaming scenario, V-UPF which terminates N3 interface in 5GC for home routed roaming scenario. See TS 23.502, clause 4.9.1.2.2. The SMF referred to here is the V-SMF for home routed roaming scenario. The presence of Internet Protocol (IP) connectivity between the Source UPF and Target NG-RAN is assumed.

During the Handover (HO) Preparation step, indicated generally as step 0 in FIG. 5, the target NG-RAN node may receive the UE capability information from source NG-RAN node. See TS 38.300, clause 9.2.3.

During the HO execution step, indicated generally as step 1 in FIG. 5, the UE may also provide a RedCap Indication in the RRC Re-Configuration Complete message.

At step 1b of FIG. 5, the target NG-RAN sends to the AMF a N2 Path Switch Request (List of PDU Sessions to Be Switched with N2 SM Information, List of PDU Sessions that failed to be established with the failure cause given in the N2 SM information element, UE Location Information, RedCap Indication). Specifically, the Target NG-RAN sends an N2 Path Switch Request message to an AMF to inform that the UE has moved to a new target cell and provides a List of PDU Sessions to Be Switched. AN Tunnel Info for each PDU Session to be switched is included in the N2 SM Information.

If redundant transmission is performed for one or more QoS Flows in the PDU Session, two AN Tunnel Info are provided by the Target NG-RAN and the Target NG-RAN indicates to the SMF one of the AN Tunnel Info is used as the redundancy tunnel of the PDU Session. See TS 23.501, clause 5.33.2.2. If only one AN Tunnel Info is provided by the Target NG-RAN for the PDU session, the SMF may release these QoS Flows by triggering PDU Session Modification procedure after the handover procedure. See TS 23.501, clause 4.3.3.

The serving PLMN ID is included in the message. The target NG-RAN shall include the PDU Session in the PDU Sessions Rejected list:
If none of the QoS Flows of a PDU Session are accepted by the Target NG-RAN; or
If the corresponding network slice is not supported in the Target NG-RAN; or
When the NG-RAN cannot set up user plane resources fulfilling the User Plane Security Enforcement with a value Required, the NG-RAN rejects the establishment of user plane resources for the PDU Session.

If the NG-RAN cannot set up user plane resources fulfilling the User Plane Security Enforcement with a value Preferred, the NG-RAN establishes the user plane resources for the PDU session and shall include the PDU Session in the PDU Sessions Modified list.

PDU Sessions Rejected contains an indication of whether the PDU session was rejected because User Plane Security Enforcement is not supported in the Target NG-RAN. Depending on the type of target cell, the Target NG-RAN includes appropriate information in this message.

For the PDU Sessions to be switched to the Target NG-RAN, the N2 Path Switch Request message shall include the list of accepted QoS Flows. For each QoS Flow accepted with an Alternative QoS Profile, the N2 SM Information shall include a reference to the fulfilled Alternative QoS Profile. See TS 23.502.

The NG-RAN (i.e., NR) may provide a RedCap Indication in the message if NG-RAN realizes the UE is RedCap UE based on the HandoverPreparationInformation in the Handover Request message in the Handover Preparation phase above, or based on the direct indication from UE in RRC Re-configuration Complete message during the Handover execution phase.

Thus, in some embodiments, an inter-RAT HO for NR redcap UE is being prepared from source ng-eNB to gNB over Xn. During the preparation phase, the target gNB receives the HandoverPreparationInformation message over the Xn-AP HANDOVER REQUEST message from the source ng-eNB. See TS 38.331.

In some embodiments, the target gNB, upon inspection of the NR RRC container, realizes that the UE RAT Capabilities corresponds explicitly to a NR RedCap UE. This can be through an explicit RedCap indication defined in the UE RAT Capabilities within the RRC container. The target gNB then formulates a new NR RedCap indication and signals this new indication to the AMF in the NG-AP PATH SWITCH REQUEST message.

In some alternative embodiments, the target gNB upon, inspection of the NR RRC container, realizes that the UE RAT Capabilities correspond implicitly to a NR RedCap UE. This can be through implicit indications of, e.g., the supported bandwidths and number of MIMO layers. The target gNB then formulates a new NR RedCap indication and signals this new indication to the AMF in the NG-AP PATH SWITCH REQUEST message.

Examples of formulating and signaling this identification is described further below, where the identification of redcap UE is coded as simple ENUMERATED (‘true’ . . . ). For example, a Path Switch Request can be sent by the NG-RAN node to inform the AMF of the new serving NG-RAN node and to transfer some NG-U DL tunnel termination point(s) to the SMF via the AMF for one or multiple PDU session resources, in the direction NG-RAN node→AMF. For example:

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | reject |
| RAN UE NGAP ID | M | | 9.3.3.2 | | YES | reject |
| Source AMF UE NGAP | M | | AMF UE NGAP | | YES | reject |
| ID | | | ID | | | |
| | | | 9.3.3.1 | | | |
| User Location | M | | 9.3.1.16 | | YES | ignore |
| Information | | | | | | |
| UE Security Capabilities | M | | 9.3.1.86 | | YES | ignore |
| PDU Session Resource | | 1 | | | YES | reject |
| to be Switched in | | | | | | |
| Downlink List | | | | | | |
| >PDU Session | | 1 . . . | | | — | |
| Resource to be | | <maxnoofPDUSessions> | | | | |
| Switched in Downlink | | | | | | |
| Item | | | | | | |
| >>PDU Session ID | M | | 9.3.1.50 | | — | |
| >>Path Switch | M | | OCTET | Containing the | — | |
| Request Transfer | | | STRING | Path Switch | | |
| | | | | Request Transfer | | |
| | | | | IE specified in | | |
| | | | | subclause 9.3.4.8. | | |
| PDU Session Resource | | 0 . . . 1 | | | YES | ignore |
| Failed to Setup List | | | | | | |
| >PDU Session | | 1 . . . | | | — | |
| Resource Failed to | | <maxnoofPDUSessions> | | | | |
| Setup Item | | | | | | |
| >>PDU Session ID | M | | 9.3.1.50 | | — | |
| >>Path Switch | M | | OCTET | Containing the | — | |
| Request Setup Failed | | | STRING | Path Switch | | |
| Transfer | | | | Request Setup | | |
| | | | | Failed Transfer IE | | |
| | | | | specified in | | |
| | | | | subclause | | |
| | | | | 9.3.4.15. | | |
| RRC Resume Cause | O | | RRC | | YES | ignore |
| | | | Establishment | | | |
| | | | Cause | | | |
| | | | 9.3.1.111 | | | |
| RedCap Identification | O | | Enumerated(‘true’ . . . ) | | YES | ignore |

| Range bound | Explanation |
|---|---|
| maxnoofPDUSessions | Maximum no. of PDU sessions allowed towards one UE. Value is 256. |

In some embodiments, the gNB may receive a RedCap Indication directly from the UE when UE performs the HO execution step (e.g., RRC Re-Configuration Complete in TS 38.331, etc.) message (e.g., as described previously, etc.). This can also be used by gNB to formulate the indication to AMF in Path Switch Request. Following the indication from target gNB, the AMF decides to either proceed with the path switch request or abort it. In case of abortion, the AMF, in a new embodiment, informs the target gNB of the reason of failure. The target gNB signals this cause of failure to the source ng-eNB.

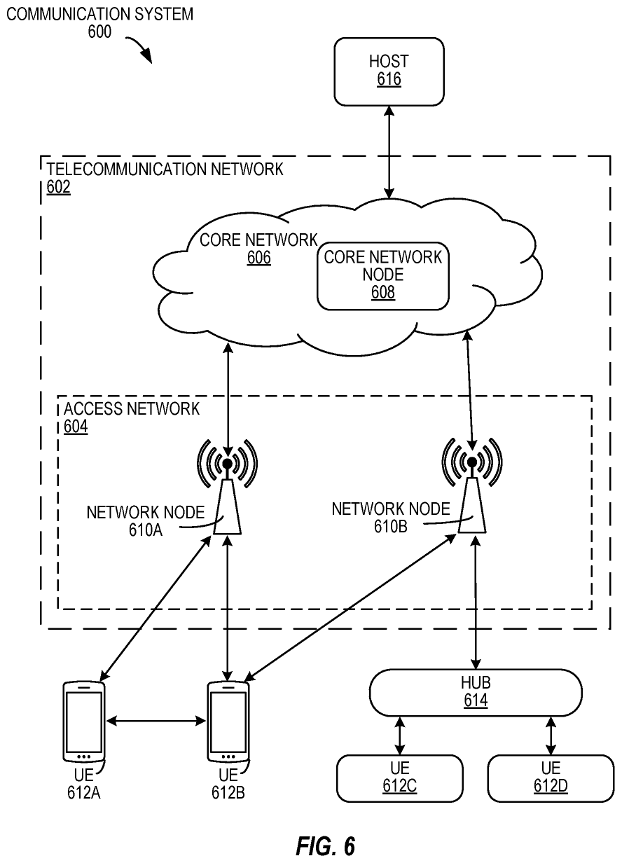

FIG. 6 shows an example of a communication system 600 in accordance with some embodiments.

In the example, the communication system 600 includes a telecommunication network 602 that includes an access network 604, such as a Radio Access Network (RAN), and a core network 606, which includes one or more core network nodes 608. The access network 604 includes one or more access network nodes, such as network nodes 610A and 610B (one or more of which may be generally referred to as network nodes 610), or any other similar Third Generation Partnership Project (3GPP) access node or non-3GPP Access Point (AP). The network nodes 610 facilitate direct or indirect connection of User Equipment (UE), such as by connecting UEs 612A, 612B, 612C, and 612D (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602, and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system 600 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 602 is a cellular network that implements 3GPP standardized features. Accordingly, the telecommunication network 602 may support network slicing to provide different logical networks to different devices that are connected to the telecommunication network 602. For example, the telecommunication network 602 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single- or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 614 communicates with the access network 604 to facilitate indirect communication between one or more UEs (e.g., UE 612C and/or 612D) and network nodes (e.g., network node 610B). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a Virtual Reality (VR) headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular in if one or more of the UEs are low energy IoT devices.

The hub 614 may have a constant/persistent or intermittent connection to the network node 610B. The hub 614 may also allow for a different communication scheme and/or schedule between the hub 614 and UEs (e.g., UE 612C and/or 612D), and between the hub 614 and the core network 606. In other examples, the hub 614 is connected to the core network 606 and/or one or more UEs via a wired connection. Moreover, the hub 614 may be configured to connect to a Machine-to-Machine (M2M) service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610B. In other embodiments, the hub 614 may be a non-dedicated hub—that is, a device which is capable of operating to route communications between the UEs and the network node 610B, but which is additionally capable of operating as a communication start and/or end point for certain data channels.

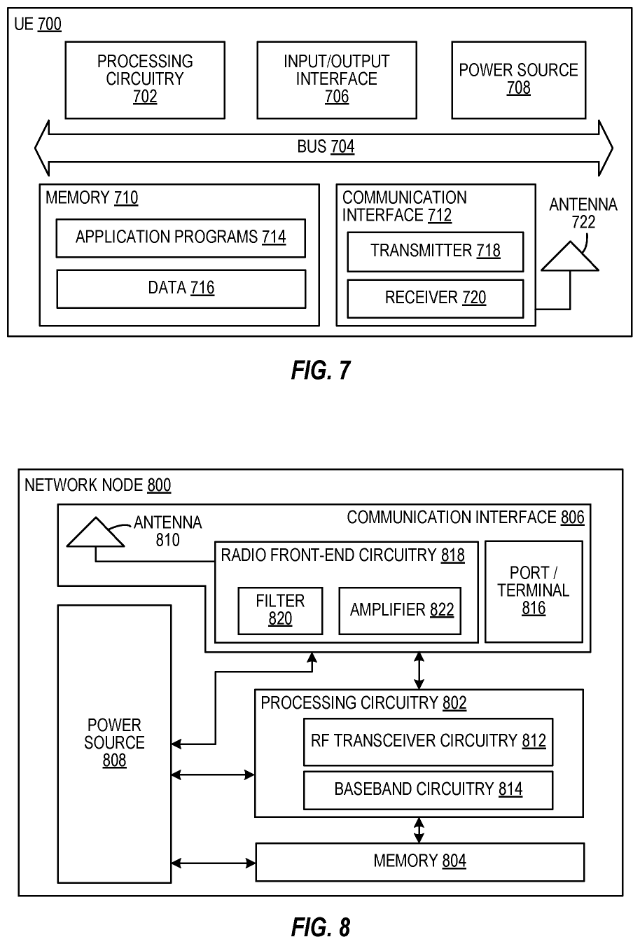

FIG. 7 shows a UE 700 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 700 includes processing circuitry 702 that is operatively coupled via a bus 704 to an input/output interface 706, a power source 708, memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 702 may include multiple Central Processing Units (CPUs).

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging the power source 708. Power circuitry may perform any formatting, converting, or other modification to the power from the power source 708 to make the power suitable for the respective components of the UE 700 to which power is supplied.

The memory 710 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 710 may allow the UE 700 to access instructions, application programs, and the like stored on transitory or non-transitory memory media, to off-load data, or to upload data. An article of manufacture, such as one utilizing a communication system, may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., the antenna 722) and may share circuit components, software, or firmware, or alternatively be implemented separately.

In the illustrated embodiment, communication functions of the communication interface 712 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 712, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 700 shown in FIG. 7.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 8 shows a network node 800 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes processing circuitry 802, memory 804, a communication interface 806, and a power source 808. The network node 800 may be composed of multiple physically separate components (e.g., a Node B component and an RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 800 may be configured to support multiple RATs. In such embodiments, some components may be duplicated (e.g., separate memory 804 for different RATs) and some components may be reused (e.g., an antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 800.

The processing circuitry 802 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 800 components, such as the memory 804, to provide network node 800 functionality.

In some embodiments, the processing circuitry 802 includes a System on a Chip (SOC). In some embodiments, the processing circuitry 802 includes one or more of Radio Frequency (RF) transceiver circuitry 812 and baseband processing circuitry 814. In some embodiments, the RF transceiver circuitry 812 and the baseband processing circuitry 814 may be on separate chips (or sets of chips), boards, or units, such as radio units and digital units. In alternative embodiments, part or all of the RF transceiver circuitry 812 and the baseband processing circuitry 814 may be on the same chip or set of chips, boards, or units.

The memory 804 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and the memory 804 are integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. The radio front-end circuitry 818 comprises filters 820 and amplifiers 822. The radio front-end circuitry 818 may be connected to the antenna 810 and the processing circuitry 802. The radio front-end circuitry 818 may be configured to condition signals communicated between the antenna 810 and the processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of the filters 820 and/or the amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface 806 may comprise different components and/or different combinations of components.

In certain alternative embodiments, the network node 800 does not include separate radio front-end circuitry 818; instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes the one or more ports or terminals 816, the radio front-end circuitry 818, and the RF transceiver circuitry 812 as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, the communication interface 806, and/or the processing circuitry 802 may be configured to perform any receiving operations and/or certain obtaining operations described herein as being performed by the network node 800. Any information, data, and/or signals may be received from a UE, another network node, and/or any other network equipment. Similarly, the antenna 810, the communication interface 806, and/or the processing circuitry 802 may be configured to perform any transmitting operations described herein as being performed by the network node 800. Any information, data, and/or signals may be transmitted to a UE, another network node, and/or any other network equipment.

The power source 808 provides power to the various components of the network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid or an electricity outlet) via input circuitry or an interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

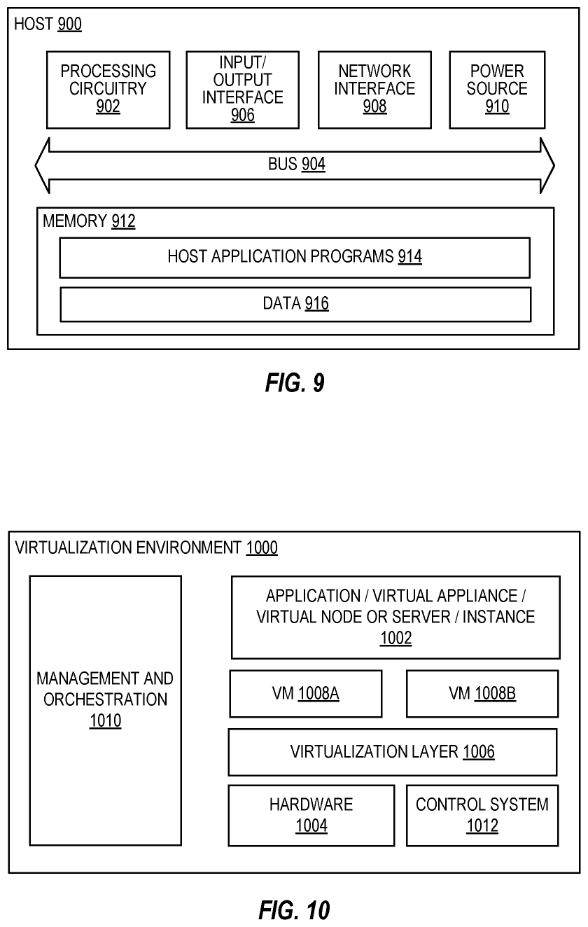

FIG. 9 is a block diagram of a host 900, which may be an embodiment of the host 616 of FIG. 6, in accordance with various aspects described herein. As used herein, the host 900 may be or comprise various combinations of hardware and/or software including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and memory 912. Other components may be included in other embodiments. Features of these components may be substantially similar to those described with respect to the devices of previous figures, such as FIGS. 7 and 8, such that the descriptions thereof are generally applicable to the corresponding components of the host 900.

The memory 912 may include one or more computer programs including one or more host application programs 914 and data 916, which may include user data, e.g. data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 914 may also provide for user authentication and licensing checks and may periodically report health, routes, and content availability to a central node, such as a device in or on the edge of a core network. Accordingly, the host 900 may select and/or indicate a different host for Over-The-Top (OTT) services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

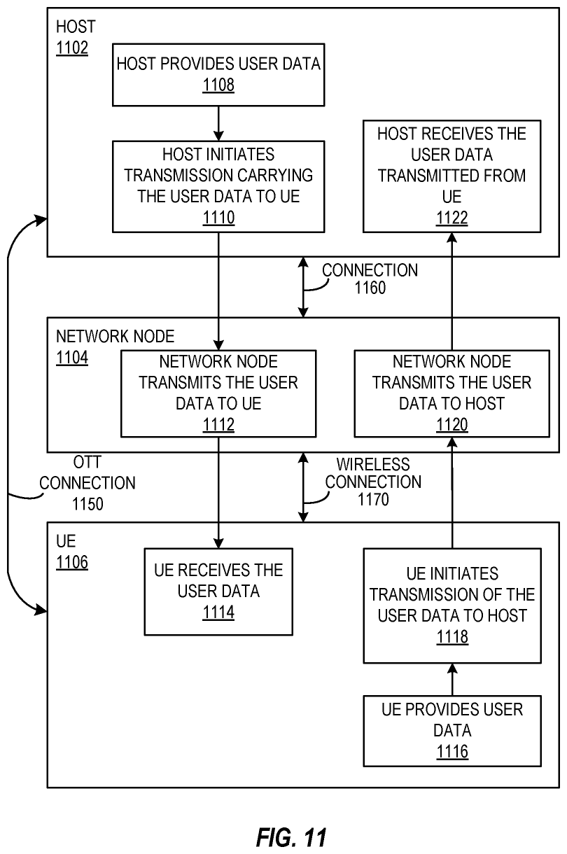

FIG. 10 is a block diagram illustrating a virtualization environment 1000 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or VM Monitors (VMMs)), provide VMs 1008A and 1008B (one or more of which may be generally referred to as VMs 1008), and/or perform any of the functions, features, and/or benefits described in relation with some embodiments described herein. The virtualization layer 1006 may present a virtual operating platform that appears like networking hardware to the VMs 1008.

The VMs 1008 comprise virtual processing, virtual memory, virtual networking, or interface and virtual storage, and may be run by a corresponding virtualization layer 1006. Different embodiments of the instance of a virtual appliance 1002 may be implemented on one or more of the VMs 1008, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1008 may be a software implementation of a physical machine that runs programs as if they were executing on a physical, non-virtualized machine. Each of the VMs 1008, and that part of the hardware 1004 that executes that VM, be it hardware dedicated to that VM and/or hardware shared by that VM with others of the VMs 1008, forms separate virtual network elements. Still in the context of NFV, a virtual network function is responsible for handling specific network functions that run in one or more VMs 1008 on top of the hardware 1004 and corresponds to the application 1002.

The hardware 1004 may be implemented in a standalone network node with generic or specific components. The hardware 1004 may implement some functions via virtualization. Alternatively, the hardware 1004 may be part of a larger cluster of hardware (e.g., such as in a data center or CPE) where many hardware nodes work together and are managed via management and orchestration 1010, which, among others, oversees lifecycle management of the applications 1002. In some embodiments, the hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1012 which may alternatively be used for communication between hardware nodes and radio units.

FIG. 11 shows a communication diagram of a host 1102 communicating via a network node 1104 with a UE 1106 over a partially wireless connection in accordance with some embodiments. Example implementations, in accordance with various embodiments, of the UE (such as the UE 612A of FIG. 6 and/or the UE 700 of FIG. 7), the network node (such as the network node 610A of FIG. 6 and/or the network node 800 of FIG. 8), and the host (such as the host 616 of FIG. 6 and/or the host 900 of FIG. 9) discussed in the preceding paragraphs will now be described with reference to FIG. 11.

Like the host 900, embodiments of the host 1102 include hardware, such as a communication interface, processing circuitry, and memory. The host 1102 also includes software, which is stored in or is accessible by the host 1102 and executable by the processing circuitry. The software includes a host application that may be operable to provide a service to a remote user, such as the UE 1106 connecting via an OTT connection 1150 extending between the UE 1106 and the host 1102. In providing the service to the remote user, a host application may provide user data which is transmitted using the OTT connection 1150.

The network node 1104 includes hardware enabling it to communicate with the host 1102 and the UE 1106 via a connection 1160. The connection 1160 may be direct or pass through a core network (like the core network 606 of FIG. 6) and/or one or more other intermediate networks, such as one or more public, private, or hosted networks. For example, an intermediate network may be a backbone network or the Internet.

The UE 1106 includes hardware and software, which is stored in or accessible by the UE 1106 and executable by the UE's processing circuitry. The software includes a client application, such as a web browser or operator-specific “app” that may be operable to provide a service to a human or non-human user via the UE 1106 with the support of the host 1102. In the host 1102, an executing host application may communicate with the executing client application via the OTT connection 1150 terminating at the UE 1106 and the host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via the connection 1160 between the host 1102 and the network node 1104 and via a wireless connection 1170 between the network node 1104 and the UE 1106 to provide the connection between the host 1102 and the UE 1106. The connection 1160 and the wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104 in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion (e.g., controlling traffic lights). As another example, the host 1102 may store surveillance video uploaded by a UE. As another example, the host 1102 may store or control access to media content such as video, audio, VR, or AR which it can broadcast, multicast, or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1150 between the host 1102 and the UE 1106 in response to variations in the measurement results. The measurement procedure and/or the network functionality for reconfiguring the OTT connection 1150 may be implemented in software and hardware of the host 1102 and/or the UE 1106. In some embodiments, sensors (not shown) may be deployed in or in association with other devices through which the OTT connection 1150 passes; the sensors may participate in the measurement procedure by supplying values of the monitored quantities exemplified above, or by supplying values of other physical quantities from which software may compute or estimate the monitored quantities. The reconfiguring of the OTT connection 1150 may include message format, retransmission settings, preferred routing, etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency, and the like by the host 1102. The measurements may be implemented in that software causes messages to be transmitted, in particular empty or ‘dummy’ messages, using the OTT connection 1150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally. Some example embodiments of the present disclosure are as follows:

### Group A Embodiments

Embodiment 1: A method performed by a target network node (204) for inter-Radio Access Technology, RAT, handover of a Wireless Communication Device, WCD, from a source network node (202) of a first RAT to the target network node (204) of a second RAT, the method comprising: receiving (FIG. 3, Step 9; FIG. 4, Step 3; FIG. 5, Steps 0 or 1), at the target network node (204), a message in association with preparation or execution of a handover of a WCD (206) from the source network node (202) of the first RAT to the target network node (204) of the second RAT, the message comprising information about one or more capabilities of the WCD (206); determining (FIG. 3, Step 10; FIG. 4, Step 4; FIG. 5, Steps 0 or 1) that the WCD (206) is a Reduced Capability, RedCap, WCD based on the information about the one or more capabilities of the WCD (206); and sending (FIG. 3, Step 10; FIG. 4, Step 4; FIG. 5, Step 1b) an indication that the WCD (206) is a RedCap WCD to a core network node.
Embodiment 2: The method of embodiment 1, wherein receiving the message comprises receiving the message from another network node during preparation for the handover of the WCD (206) from the source network node (202) to the target network node (204).
Embodiment 3: The method of embodiment 2, wherein the message comprises a transparent container information element that comprises the information about the one or more capabilities of the WCD (206).
Embodiment 4: The method of embodiment 3, wherein the information comprised in the transparent container information element is transparent to one or more network nodes through which the transparent container propagated from the source network node (202) to the target network node (204).
Embodiment 5: The method of any of embodiments 2-4, wherein: the message comprising the information about the one or more capabilities of the WCD (206) is a Handover Request message; and sending the indication that the WCD is a RedCap WCD to the core network node comprises sending a Handover Request Acknowledge message to the core network node, the Handover Request Acknowledge message comprising the indication that the WCD is a RedCap WCD.
Embodiment 6: The method of any of embodiments 2-5, wherein receiving the message comprising the information about the one or more capabilities of the WCD (206) comprises receiving the message from the core network node.
Embodiment 7: The method of embodiment 1, wherein receiving the message comprises receiving the message during execution of the handover of the WCD (206) from the source network node (202) to the target network node (204).
Embodiment 8: The method of embodiment 7, wherein receiving the message during execution of the handover of the WCD (206) from the source network node (202) to the target network node (204) comprises receiving a Handover Confirm message from the WCD (206) during execution of the handover of the WCD (206) from the source network node (202) to the target network node (204), the Handover Confirm message comprising the information about the one or more capabilities of the WCD (206).
Embodiment 9: The method of embodiment 8, wherein sending the indication that the WCD (206) is a RedCap WCD to the core network node comprises sending a Handover Notify message to the core network node, the Handover Notify message comprising the indication that the WCD (206) is a RedCap WCD.
Embodiment 10: The method of embodiment 1, wherein sending the indication that the WCD (206) is a RedCap WCD to the core network node comprises sending a N2 Path Switch Request message to the core network node, the N2 Path Switch Request message comprising the indication that the WCD (206) is a RedCap WCD.
Embodiment 11: The method of embodiment 10, wherein receiving the message that comprises the information about the one or more capabilities of the WCD (206) comprises receiving a Handover Request message comprising handover preparation information, the handover preparation information comprising the information about the one or more capabilities of the WCD (206).
Embodiment 12: The method of embodiment 10, wherein receiving the message that comprises the information about the one or more capabilities of the WCD (206) comprises receiving a Radio Resource Control, RRC, Re-configuration Complete message from the WCD (206) during execution of the handover, the RRC Re-configuration Complete message comprising the information about the one or more capabilities of the WCD (206).
Embodiment 13: The method of embodiment 10, wherein receiving the message that comprises the information about the one or more capabilities of the WCD (206) comprises receiving a dedicated random access preamble that indicates that the WCD (206) is a RedCap WCD.
Embodiment 14: The method of any of embodiments 1 to 13, wherein the first RAT is Long Term Evolution, LTE, and the second RAT is New Radio, NR.
Embodiment 15: The method of any of embodiments 1 to 14, wherein the target network node (204) is a gNB, and the core network node is an Access and Mobility Management Function, AMF.
Embodiment 16: The method of embodiment 15, wherein the source network node (202) is an Evolved node B, eNB node.
Embodiment 17: The method of embodiment 15, wherein the source network node (202) is a Next Generation evolved Node B, ng-eNB, node.
Embodiment 18: The method of any of embodiments 1 to 17, wherein: (a) the information about the one or more capabilities of the WCD (206) comprises an explicit indication that the WCD (206) is a RedCap WCD; or (b) the information about the one or more capabilities of the WCD (206) comprises information that implicitly indicates that the WCD (206) is a RedCap WCD.
Embodiment 19: A target network node (204) for inter-Radio Access Technology, RAT, handover of a Wireless Communication Device, WCD, from a source network node (202) of a first RAT to the target network node (204) of a second RAT, the target network node (204) adapted to: receive (FIG. 3, Step 9; FIG. 4, Step 3; FIG. 5, Steps 0 or 1), at the target network node (204), a message in association with preparation or execution of a handover of a WCD (206) from the source network node (202) of the first RAT to the target network node (204) of the second RAT, the message comprising information about one or more capabilities of the WCD (206); determine (FIG. 3, Step 10; FIG. 4, Step 4; FIG. 5, Steps 0 or 1) that the WCD (206) is a Reduced Capability, RedCap, WCD based on the information about the one or more capabilities of the WCD (206); and send (FIG. 3, Step 10; FIG. 4, Step 4; FIG. 5, Step 1b) an indication that the WCD (206) is a RedCap WCD to a core network node.
Embodiment 20: The target network node (204) of embodiment 19, wherein the target network node (204) is further adapted to perform the method of any of embodiments 2-18.
Embodiment 21: A target network node (800) for inter-Radio Access Technology, RAT, f handover of a Wireless Communication Device, WCD, from a source network node (202) of a first RAT to the target network node (800) of a second RAT, comprising: one or more transmitters (812); one or more receivers (812); and processing circuitry (802), wherein the processing circuitry (802) is configured to cause the target network node (800) to: receive (FIG. 3, Step 9; FIG. 4, Step 3; FIG. 5, Steps 0 or 1), at the target network node (204), a message in association with preparation or execution of a handover of a WCD (206) from the source network node (202) of the first RAT to the target network node (204) of the second RAT, the message comprising information about one or more capabilities of the WCD (206); determine (FIG. 3, Step 10; FIG. 4, Step 4; FIG. 5, Steps 0 or 1) that the WCD (206) is a Reduced Capability, RedCap, WCD based on the information about the one or more capabilities of the WCD (206); and send (FIG. 3, Step 10; FIG. 4, Step 4; FIG. 5, Step 1b) an indication that the WCD (206) is a RedCap WCD to a core network node.
Embodiment 22: The target network node (800) of embodiment 21, wherein the processing circuitry (804) is further configured to cause the target network node (800) to perform the method of any of embodiments 2-18.
Embodiment 23: The method of any of the previous embodiments, further comprising: obtaining user data; and forwarding the user data to a host or a user equipment.

### Group B Embodiments

Embodiment 24: A network node for operation as a target network node (204) for inter-Radio Access Technology, RAT, handover of a Wireless Communication Device, WCD, from a source network node (202) of a first RAT to the target network node (204) of the second RAT, the network node comprising processing circuitry configured to perform any of the steps of any of the Group A embodiments and power supply circuitry configured to supply power to the processing circuitry.
Embodiment 25: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group A embodiments to transmit the user data from the host to the UE.
Embodiment 26: The host of the previous embodiment, wherein: the processing circuitry of the host is configured to execute a host application that provides the user data; and the UE comprises processing circuitry configured to execute a client application associated with the host application to receive the transmission of user data from the host.
Embodiment 27: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group A embodiments to transmit the user data from the host to the UE.
Embodiment 28: The method of the previous embodiment, further comprising, at the network node, transmitting the user data provided by the host for the UE.
Embodiment 29: The method of any of the previous 2 embodiments, wherein the user data is provided at the host by executing a host application that interacts with a client application executing on the UE, the client application being associated with the host application.
Embodiment 30: A communication system configured to provide an over-the-top service, the communication system comprising: a host comprising processing circuitry configured to provide user data for a user equipment (UE), the user data being associated with the over-the-top service and a network interface configured to initiate transmission of the user data toward a cellular network node for transmission to the UE, the network node having a communication interface and processing circuitry, the processing circuitry of the network node configured to perform any of the operations of any of the Group A embodiments to transmit the user data from the host to the UE.
Embodiment 31: The communication system of the previous embodiment, further comprising: the network node; and/or the user equipment.
Embodiment 32: A host configured to operate in a communication system to provide an over-the-top (OTT) service, the host comprising: processing circuitry configured to initiate receipt of user data and a network interface configured to receive the user data from a network node in a cellular network, the network node having a communication interface and processing circuitry, the processing circuitry of the network node configured to perform any of the operations of any of the Group A embodiments to receive the user data from a user equipment (UE) for the host.
Embodiment 33: The host of the previous 2 embodiments, wherein: the processing circuitry of the host is configured to execute a host application, thereby providing the user data; and the host application is configured to interact with a client application executing on the UE, the client application being associated with the host application.
Embodiment 34: The host of the any of the previous 2 embodiments, wherein the initiating receipt of the user data comprises requesting the user data.
Embodiment 35: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group A embodiments to receive the user data from the UE for the host.
Embodiment 36: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1-23. (canceled)

24. A method performed by a target network node for inter-Radio Access Technology, RAT, handover of a Wireless Communication Device, WCD, from a source network node of a first RAT to the target network node of a second RAT, the method comprising:
receiving, at the target network node, a message in association with preparation or execution of a handover of a WCD from the source network node of the first RAT to the target network node of the second RAT, the message comprising information about one or more capabilities of the WCD;
determining that the WCD is a Reduced Capability, RedCap, WCD based on the information about the one or more capabilities of the WCD; and
sending an indication that the WCD is a RedCap WCD to a core network node.

25. The method of claim 24, wherein receiving the message comprises receiving the message from another network node during preparation for the handover of the WCD from the source network node to the target network node.

26. The method of claim 25, wherein the message comprises a transparent container information element that comprises the information about the one or more capabilities of the WCD.

27. The method of claim 26, wherein the information comprised in the transparent container information element is transparent to one or more network nodes through which the transparent container propagated from the source network node to the target network node (204).

28. The method of claim 25, wherein the other network node is the core network node.

29. The method of claim 24, wherein:
the message comprising the information about the one or more capabilities of the WCD (206) is a Handover Request message; and
sending the indication that the WCD is a RedCap WCD to the core network node comprises sending a Handover Request Acknowledge message to the core network node, the Handover Request Acknowledge message comprising the indication that the WCD is a RedCap WCD.

30. The method of claim 24, wherein receiving the message comprises receiving the message during execution of the handover of the WCD from the source network node to the target network node.

31. The method of claim 30, wherein receiving the message during execution of the handover of the WCD from the source network node to the target network node comprises receiving a message from the WCD comprising the information about one or more capabilities of the WCD.

32. The method of claim 30, wherein receiving the message during execution of the handover of the WCD from the source network node to the target network node comprises receiving a Handover Confirm message from the WCD during execution of the handover of the WCD from the source network node to the target network node, the Handover Confirm message comprising the information about the one or more capabilities of the WCD.

33. The method of claim 32, wherein sending the indication that the WCD is a RedCap WCD to the core network node comprises sending a Handover Notify message to the core network node, the Handover Notify message comprising the indication that the WCD is a RedCap WCD.

34. The method of claim 24, wherein sending the indication that the WCD is a RedCap WCD to the core network node comprises sending a N2 Path Switch Request message to the core network node, the N2 Path Switch Request message comprising the indication that the WCD is a RedCap WCD.

35. The method of claim 34, wherein receiving the message that comprises the information about the one or more capabilities of the WCD comprises receiving a Handover Request message comprising handover preparation information, the handover preparation information comprising the information about the one or more capabilities of the WCD.

36. The method of claim 34, wherein receiving the message that comprises the information about the one or more capabilities of the WCD comprises receiving a Radio Resource Control, RRC, Re-configuration Complete message from the WCD during execution of the handover, the RRC Re-configuration Complete message comprising the information about the one or more capabilities of the WCD.

37. The method of claim 34, wherein receiving the message that comprises the information about the one or more capabilities of the WCD comprises receiving a dedicated random access preamble that indicates that the WCD is a RedCap WCD.

38. The method of claim 24, wherein:
(a) the information about the one or more capabilities of the WCD comprises an explicit indication that the WCD is a RedCap WCD; or
(b) the information about the one or more capabilities of the WCD comprises information that implicitly indicates that the WCD is a RedCap WCD.

39. A target network node for inter-Radio Access Technology, RAT, handover of a Wireless Communication Device, WCD, from a source network node of a first RAT to the target network node of a second RAT, the target network node adapted to:
receive, at the target network node, a message in association with preparation or execution of a handover of a WCD from the source network node of the first RAT to the target network node of the second RAT, the message comprising information about one or more capabilities of the WCD;
determine that the WCD is a Reduced Capability, RedCap, WCD based on the information about the one or more capabilities of the WCD; and
send an indication that the WCD is a RedCap WCD to a core network node.

40. A target network node for inter-Radio Access Technology, RAT, handover of a Wireless Communication Device, WCD, from a source network node of a first RAT to the target network node of a second RAT, comprising:
one or more transmitters;
one or more receivers; and
processing circuitry, wherein the processing circuitry is configured to cause the target network node to:
receive, at the target network node, a message in association with preparation or execution of a handover of a WCD from the source network node of the first RAT to the target network node of the second RAT, the message comprising information about one or more capabilities of the WCD;
determine that the WCD is a Reduced Capability, RedCap, WCD based on the information about the one or more capabilities of the WCD; and
send an indication that the WCD is a RedCap WCD to a core network node.
